(19) United States
(12) Patent Application Publication
(10) Pub. No.: US 2026/0218518 A1
(43) Pub. Date: Jul. 30, 2026

(54) FOLDABLE RAMP ASSEMBLY

(71) Applicant: The Landmark Group, Inc. (DBA National Ramp), Valley Cottage, NY (US)

(72) Inventors: Quoc Tran, Valley Cottage, NY (US); Jay Mornan, New City, NY (US); Garth Walker, Valley Cottage, NY (US)

(21) Appl. No.: 19/041,580

(22) Filed: Jan. 30, 2025

(51) Int. Cl. E04F 11/00; B65G 69/30

(52) U.S. Cl. CPC E04F 11/002; B65G 69/30; E04F 2011/005

(57) ABSTRACT

A foldable ramp assembly that is relatively long yet portable with a structure that comprises three ramp sections, a pair of first hinge assemblies for rotatably coupling the first and second ramp sections about a first pivot axis, and a pair of second hinge assemblies for rotatably coupling the second and third ramp sections about a second pivot axis. When fully opened, the three ramp sections extend along a single plane to provide a continuous elongated ramp. When fully closed, the structures of the ramp sections and hinge assemblies allow the ramp sections to be stowed in a compact configuration where the three sections are disposed adjacent to one in parallel fashion. The ramp assembly can have wheels for ease of transportability and the hinge assemblies can be disconnected to allow for the three ramp sections to be moved or stored separate from one another.

### BACKGROUND OF THE INVENTION

### 1. Field of the Invention

The present invention relates to a ramp assembly, and more particularly, to a portable three-section ramp assembly that is relatively long and capable to support a wheelchair or other mobility devices, carts, pedestrians, and other things.

### 2. Description of the Related Art

Ramps are commonly used in homes and public spaces to provide safe access for individuals with wheelchairs or mobility devices, as well as to assist workers in transporting goods on freight carts between locations. Although longer ramps provide smoother and safer inclines, they often pose challenges regarding portability and storage. There is an increasing demand for longer ramps to meet the needs of users with mobility devices and freight carts, among others. The longer ramps offer a more gradual incline, enhancing safety and usability, particularly when accessing elevated or uneven surfaces. However, despite their benefits, longer ramps are cumbersome, difficult to transport, and require significant storage space, therefore limiting their practicality in residential and commercial settings.

In view of the foregoing, there is a need for a ramp assembly that effectively combines the advantages of length with the practicality of ease of removal, transport, and storage.

### OBJECTS AND SUMMARY OF THE INVENTION

In view of the foregoing, it is an object of the present invention to provide a ramp assembly that is easy to assemble, disassemble, transport and store. The ramp assembly preferably is portable, allowing users to easily move it from one location to another. It preferably has a compact structure for convenient folding or disassembly, making it suitable for storage in small spaces, such as closets, vehicle trunks, or storage rooms.

It is a further object to provide a ramp assembly that offers a safe, stable, and user-friendly platform that bridges different surface heights, thus reducing the physical effort required by those with mobility challenges.

The ramp assembly preferably is lightweight yet durable, ensuring that it can be easily handled by users of various physical capabilities while maintaining structural integrity.

It is another object to provide a ramp assembly with multiple transition plates to enhance accessibility by allowing smoother transitions between surfaces of differing elevations.

It is a further object of the present invention to provide a ramp assembly that is easy to operate without requiring extra or unusual tools.

Other objects will be appreciated from the description herein.

To achieve one or more of the foregoing and other objects, a brief summary of the present invention, in accordance with certain embodiments of the invention, is a foldable ramp assembly that comprises three ramp sections, a pair of first hinge assemblies that are coupled to the first and second ramp sections and enable/allow the first and second ramp sections to be rotatable relative to one another about a first pivot axis, a pair of second hinge assemblies coupled to the second and third ramp sections and enable/allow the second and third ramp sections to be rotatable relative to one another about a second pivot axis. In accordance with the invention, the structures of the hinge assemblies and ramp sections enable for the ramp assembly, when fully opened to be fully extended whereby the three ramp sections extend along a plane to provide a continuous elongated surface/ramp, and when fully closed the three ramp sections are disposed immediately adjacent to one another in separate, parallel planes to provide a compact structure to allow for ease of movement and storage.

As an aspect of the invention, the first and second hinge assemblies are configured, when the foldable ramp assembly is in the fully open position, to enable rotation of the first and third ramp sections relative to the second ramp section in directions opposite to one another.

As another aspect of the invention, when the foldable ramp assembly is in the fully closed position, the first and third ramp sections are disposed on the same side of the second ramp section.

As a further aspect of the invention, each of the three ramp sections has a respective pair of side rails that extend upward from opposing edges of each ramp section's top surface.

As a feature of this aspect, each of the first hinge assemblies is coupled to respective rails of the first and second ramp sections to define the first pivot axis about which the first and second ramp sections rotate relative to one another. Further, each of the second hinge assemblies is coupled to respective rails of the second and third ramp sections to define the second pivot axis about which the second and third ramp sections rotate relative to one another. The first and second pivot axes are disposed at different heights relative to the top surfaces of the ramp section when in the fully open position to allow for the ramp sections to be stowed on top of one another in parallel fashion when the ramp is in the fully closed position.

As another feature of this aspect, the first ramp section has a width smaller than a width of the second ramp section, and the width of the second ramp section is smaller than a width of the third ramp section so that the respective rails of each side of the first, second, and third ramp sections are disposed adjacent to one another when the ramp sections are in the fully closed position.

As a more detailed aspect of the invention, each of the hinge assemblies has first and second plate units that are rotatably coupled to one another. The first plate unit comprises an outer plate, an inner plate, and a middle plate disposed between the outer and inner plates. The middle plate is configured to provide a space between the outer and inner plates. Further, the second plate unit is a single plate and is configured to be rotatable relative to the first plate unit so that a portion of the second plate unit is disposed in the space between the outer and inner plates of the first plate unit when the ramp sections are in the fully closed position.

As a feature of this aspect, the inner plate of the first plate unit of each of the first hinge assemblies is coupled to opposing sides of the first ramp sections. The second plate of each of the first hinge assemblies is coupled to opposing sides of the second ramp section. And, positions at which each inner plate is coupled to the first ramp section is disposed along a different respective plane than a corresponding respective plane at which each second plate is coupled to the second ramp section.

As a further aspect, each of the first and second plate units have respective common holes that are positionally aligned when the ramp is in the fully open position to receive a locking pin to prevent rotational movement of each respective hinge assemble so that the ramp sections are not able to rotate relative to one another with all the locking pins inserted in this arrangement.

As a feature of this aspect, the common hole of the second plate unit of each of the hinge assemblies is elongated to allow for the locking pins to be insertable when there is an alignment variance.

As a further aspect of the invention, each of the first hinge assemblies includes a rotatable wheel to allow the ramp assembly to be moved via rolling over the wheels when the ramp sections are in the fully closed position.

As another aspect of the invention, the hinge assemblies can be disassembled into their respective two halves/parts to allow for each of the ramp sections to be fully disconnected from one another for ease of transportability and storage. For instance, each ramp section can be stored at a different location, if necessary desired, and each ramp section can be transported separate from the other ramp sections.

These and other embodiments, aspects and features of the present invention are described in the following detailed description. In addition, various other objects, advantages and features of the present invention will become readily apparent to those of ordinary skill in the art from the following detailed description of the invention.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 shows a perspective view of the ramp of the invention in a fully folded (or closed) position.

FIG. 2. illustrates the three sections of the ramp in accordance with certain embodiments of the invention.

FIG. 3A shows various details of the ramp's hinge assemblies in accordance with certain embodiments of the invention.

FIGS. 3B, 3C, and 3D are various views that show the transition plate.

FIGS. 4A and 4B are bottom views of the ramp.

FIG. 5 is a side view of the ramp.

FIGS. 6A and 6B are schematic perspective views of the first and second hinge assemblies of the ramp.

FIGS. 6C and 6D are exploded views of the hinge assemblies.

FIG. 7 is an exploded view of the entire ramp in accordance with certain embodiments.

FIGS. 8A and 8B show the outer structure and the mounting location of one portion of a hinge on a ramp assembly.

FIG. 8C is a bottom, perspective view of a ramp assembly with its hinges.

FIG. 9A is a top, perspective view of the second (center) ramp section with its hinges.

FIG. 9B is a bottom, perspective view of the center ramp section.

FIG. 10A is a top, perspective view of the third ramp section.

FIG. 10B is a bottom, perspective view of the third ramp section.

FIGS. 11A through 11H show the various transitional states from a fully open (i.e., deployed) ramp to a fully folded (closed) ramp.

FIG. 12 show the states/positions of the hinge assemblies during the various transitions/states of the ramp shown in FIGS. 11A through 11H.

FIG. 13 is a schematic view of a particular embodiment of the present invention, showing the hinge assemblies along with locking pins and wheels.

FIGS. 14A through 14H schematically illustrate the various hinge plates of hinge assemblies of the present invention, in accordance with certain embodiments.

FIGS. 15A through 15F shows portions of the side rails of the ramps in accordance with certain embodiments.

FIG. 16 illustrates a user moving the ramp using the wheels and the handle.

### DETAILED DESCRIPTION OF INVENTION

The following is a detailed discussion of the foldable ramp of the present invention. The accompanying figures briefly summarized above are presented to aid in the understanding of the invention. It is appreciated, however, that the figures and illustrations therein are illustrative of various embodiments of the invention and are not intended to limit the invention solely to precisely what is shown. Accordingly, various changes to the structures of the various components shown may be modified and be within the present invention as would be appreciated by those of ordinary skill in the art.

The inventive foldable ramp includes or otherwise embodies multiple components, structures, and functions. For convenience, these components, structures, and functions are divided into the following groups of discussion: (A) Ramp Structure and Sections; (B) Hinge Assemblies; (C) Plate Units-Stacking Structure and Interconnections; (D) Positions and Movement; (E) Locking Mechanism; (F) Mounting points of Hinge Plates and Siderails; and (G) Handle and Wheels for Transportation of the Ramp. These section headings and all other headings used herein are provided for convenience and are not intended to limit the invention in any manner.

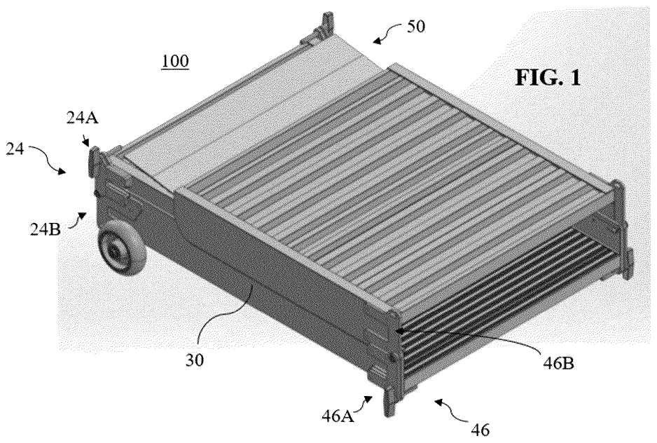

Referring now to the accompanying drawings, FIG. 1 is a schematic illustration that shows a perspective view of a ramp 100 in a folded (or closed) position in accordance with the present invention. As illustrated, the ramp 100 includes hinge assemblies 24 and 46, side rails 30, and transition plates 50. The ramp includes other components to be discussed.

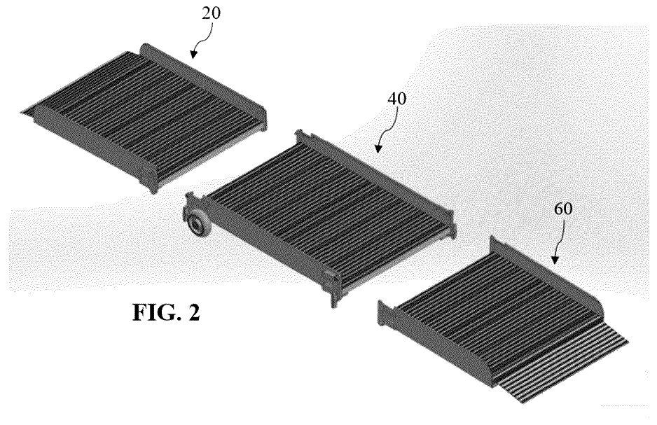

The ramp 100 is configured to transition between at least two positions: (1) a folded position, as shown in FIG. 1, where a first ramp section 20, a second ramp section 40, and a third ramp section 60, with such sections labelled in FIG. 2, are stacked in a substantially (or mostly) parallel arrangement in overlapping manner; and (2) an open position, such as shown in FIGS. 2-5. In the open position, the three ramp sections 20, 40, 60 align generally horizontally and are substantially co-planar.

A set of hinge assemblies are employed to connect/couple the three ramp sections together. As described further below, the hinge assemblies are mounted to respective side rails of the ramp section. The hinge assemblies rotatably couple the ramp sections thus allowing the ramp 100 to transition between its folded and open positions.

### Ramp Structure and Sections

FIG. 2 illustrates the ramp in a disassembled state. As shown, the three ramp sections are separated. Each ramp section includes a planar deck with a top surface that preferably is textured to provide improved traction. Each ramp section 20, 40, and 60 preferably is made from durable metal, such as aluminum or steel, selected for their strength and rigidity. Other materials may be employed, as would be appreciated by those of ordinary skill in the art. Moreover, section of materials and dimensions of the internal components of the ramp sections will be based on the specific performance requirements of the ramp. In general, various factors to be taken into account include maximum load capacity, environmental conditions, desired balance between weight and durability, among other factors.

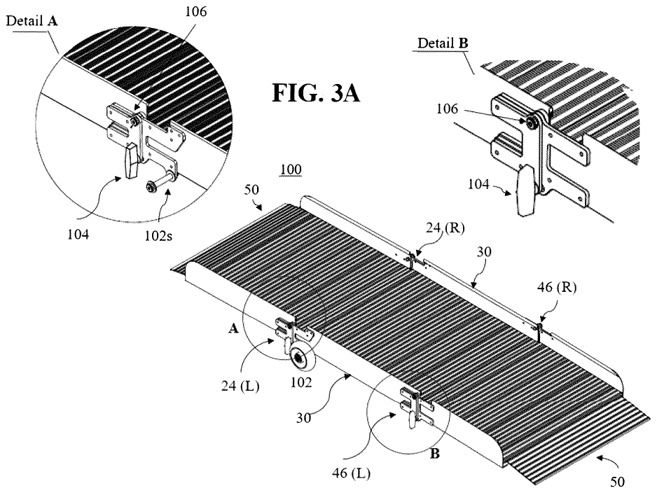

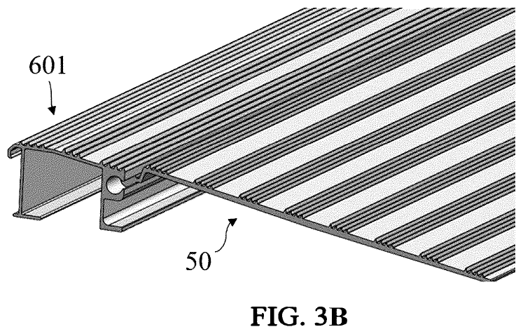

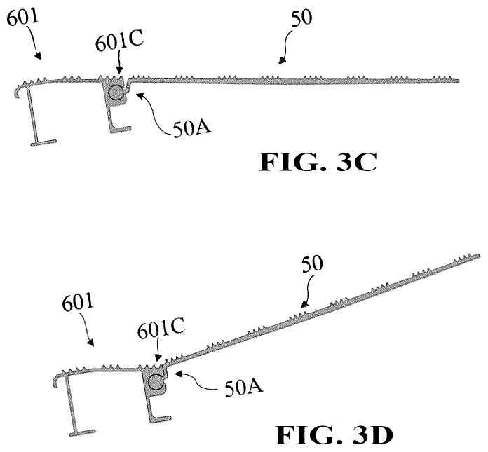

Ramp 100 of the invention includes side rails 30, such as shown in FIG. 3A. The side rails extend upwardly from the two ends of each ramp section's top surface. As illustrated, side rails 30 extend upwardly at right angles with respect to each top surface and extend along the lengthwise sides of each ramp section, thus providing guidance and added safety for users. In certain embodiment, the proximate ends of the side rails on the first and third ramp sections 20 and 60 preferably are rounded for improved safety.

A pair of transition plates 50 are shown in FIG. 3A to facilitate smooth transitions between the ramp and adjacent surfaces. In the embodiment shown in FIG. 3A, transition plates 50 are substantially co-planar with respect to their connected section and may be slightly angled to providing a resting surface, ensuring smoother transitioning between surfaces as well as providing a more secure and stable resting profile.

FIGS. 3B, 3C, and 3D illustrate an exemplary connection between a profile of a ramp section, such as the third section 60, and the transition plate 50. As shown in FIGS. 3B and 3C, a profile 601 of the section 60 includes a “C”-shaped channel 601C that spans the width of the ramp section 60, providing a receptacle for the connection. The transition plate 50 features a rounded or near-rounded edge 50A at one end, dimensioned to fit and securely within the “C”-shaped channel 601C. This connection ensures limited rotational movement of the rounded edge 50A of the transition plate within the “C”-shaped channel 601C of the ramp section, allowing the transition plate 50 to pivot relative to the third ramp section 60 within a controlled range of motion.

More specifically, the connection allows the transition plate 50 to 1) align with the surface of the ramp section 60, as shown in FIG. 3C, creating a continuous, leveled surface across the connection, 2) tilt at an angle relative to the surface of the ramp section 60, as shown in FIG. 3D, to accommodate uneven surfaces while maintaining a stable and functional configuration.

The above connection of the ramp section and transition plate enables the transition plate to adjust its angle relative to the surface of the ramp section, facilitating surface level adjustments depending on the ground or surface on which the ramp is placed, which ensures that the transition plate can maintain proper alignment with the ramp section, even on uneven or sloped surfaces.

The lengths of the transition plates may differ from that shown in the figures. In other embodiments, the transition plates are curved. In yet further embodiments, the transition plates are omitted from the ramp.

The three ramp sections are shown in the figures to have similar lengths, thus providing uniform appearance. In other embodiments, the ramp sections have substantially different lengths. For instance, the center ramp section 40 may be much longer than the other ramp sections for any intended purpose. Accordingly, the length of each ramp section is determined in manners appreciated by those of ordinary skill in the art to ensure practicality and suitability for the ramp's intended use. Factors such as ease of folding, portability, stability in the open position, and the ability to span desired distances effectively are considered when determining the length of each ramp section.

As described in detail in the section to follow, and as shown in FIG. 2, the hinge assemblies that couple the ramp sections are designed to be separated to fully disconnect the three ramp sections from one another. Accordingly, with each ramp section disconnected from the other sections, each ramp section can be independently carried or stored. Thus, the ramp sections in accordance with invention may be stored in a relatively compact space, such as the trunk of a vehicle or other form of storage compartment. Such modular configuration of the ramp of the invention thus offers convenience and flexibility for users who require a ramp that is portable and easily to store.

### Hinge Assemblies

The hinge assemblies of the ramp of the present invention are configured to facilitate transitions between the open and folded positions of the ramp. The hinge assemblies serve as pivotal connectors between adjacent sections, allowing the ramp to transition from the open to the folded position.

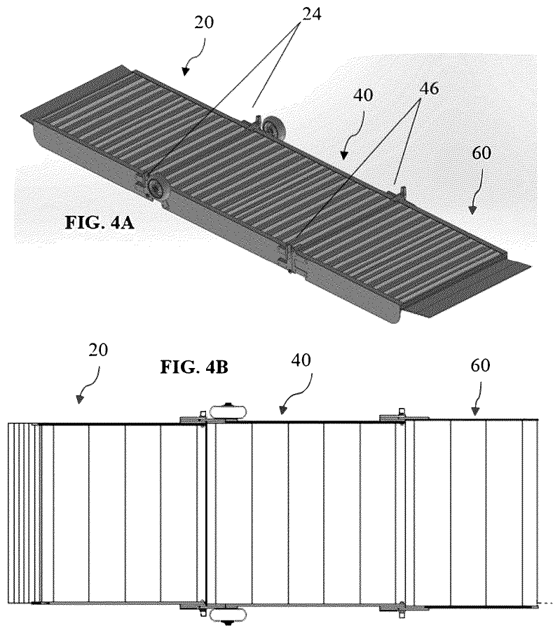

Turning now to FIGS. 3-7, the hinge assemblies of the ramp 100 and the configuration for facilitating ramp transitions will be described in detail. As illustrated in FIG. 4A, the ramp 100 includes two hinge assemblies, namely, a first hinge assembly 24 and a second hinge assembly 46. The first hinge assembly 24 is comprised of a pair of hinge components, 24 (L) and 24 (R), located on opposite (left and right) side rails of the first and second ramp section 20 and 40. The first hinge assembly 24 (L, R) pivotally connects the first and second ramp sections 20 and 40 together.

Similarly, the second hinge assembly 46 is comprises of a pair of hinge components 46(L) and 46(R) that are disposed on left and right side rails of the second and third ramp sections 40 and 60. Likewise, acting as pivotal connectors, the second hinge assembly 46(L, R) enables the third ramp section 60 to rotate relative to the second ramp section 40.

Collectively, the hinge assemblies 24 and 46 facilitate the entire transition between the open and folded positions of the ramp. Specifically, by pivoting the first hinge assembly 24, the first ramp section 20 can be positioned over the second ramp section 40, with top surfaces of the two sections facing each other. Then, by pivoting the second hinge assembly 46, the third ramp section 60 is positioned over the first ramp section 20, with the top surface of the third ramp section 60 facing a back surface of the first second 20. Thus, the ramp is in the folded position with the three sections (20, 40, 60) stacked and substantially parallel to each another.

To transition the ramp back to the open position, the process is reversed. The second hinge assembly 46 is first pivoted to lift the third ramp section 60 from its folded position and align it with the second ramp section 40. Then, the first hinge assembly 24 is pivoted, raising the first ramp section 20 from its stacked position and aligning it with the second ramp section 40. As both the first and third ramp sections are moved into place, top surfaces of the three sections are extending and substantially co-planar. This coordinated movement makes the ramp to transition back to the open position, ready for use.

Hinge assemblies 24 (L) and 46 (L), are described in further detail in the following section. The right-side hinge assemblies 24 (R) and 46 (R) have constructions that mirror hinge assemblies 24 (L) and 46 (L) and, thus, a detailed discussion of hinge assemblies 24 (R) and 46 (R) is omitted.

### Plate Units—Stacking Structure and Interconnections

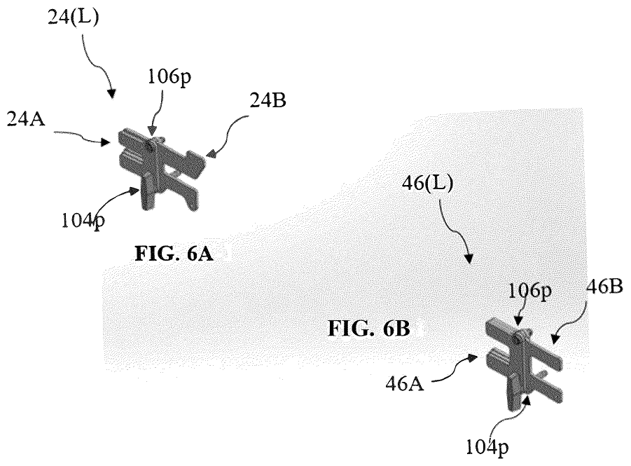

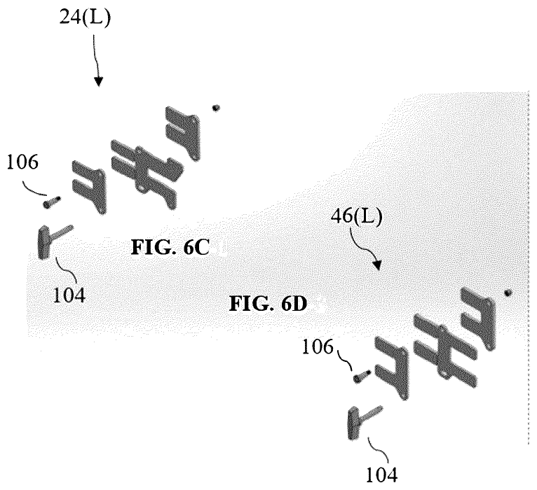

FIGS. 6A-6D provide perspective views and exploded views, respectively, of the left side of the first and second hinge assemblies 24(L) and 46(L) of ramp 100 when the hinges are in their open positions. The first hinge assembly 24(L) is comprised of a first plate unit 24A and a second plate unit 24B. The second hinge assembly 46(L) is comprised of a third plate unit 46A and a fourth plate unit 46B.

As shown in FIGS. 6A and 6B, the first plate unit 24A and the third plate unit 46A are each structured/configured with a three-layer hinge configuration with a central/middle layer sandwiched between inner and outer layers in accordance with the invention. The second plate unit 24B and the fourth plate unit 46B each consists of a single hinge plate.

In the first hinge assembly 24, the first plate unit 24A and the second plate unit 24B are joined at a pivot hole 106p through which a rotation shaft 106 is inserted. This pivot hole 106p serves as a rotation point and is specifically configured to accommodate the rotation shaft 106, establishing a rotation axis between the two plate units.

The pivot hole 106p may be configured to be slightly larger in diameter than the rotation shaft 106, enabling smooth rotational movement while minimizing lateral play. In certain embodiments, the pivot hole 106p may be equipped with bushings or bearing inserts to reduce friction, improve stability, and prolong the hinge assembly's operational lifespan.

A common hole 104p is disposed beneath the rotation shaft 106 to receive a locking pin 104. When the locking pin 104 is inserted into the common hole, the first and second plate units are secured together thus preventing pivoting. By locking the plates, the mechanism enhances the overall functionality and safety of the ramp, particularly when it is in use or when additional force is applied to the ramp's sections.

The second hinge assembly 46 shown in FIG. 6B has a similar configuration. A pivot hole 106p accommodates the rotation shaft 106, creating a pivot axis between the third plate unit 46A and the fourth plate unit 46B. A common hole 104p at the bottom of the structure receives a locking pin 104 to secure the two plate units thereby preventing unintended rotation.

In this embodiment, the pivot hole 106p and the common hole 104p are located within an overlapping area of the stacked plates. In a preferred embodiment, the distance between the pivot hole 106p and the common hole 104p is configured to be maximized within this overlapping region, in order to enhance the hinge assembly's structural integrity and stability. With the maximized separation between the pivot and lock points, it is possible to reduce stress concentrations during operation.

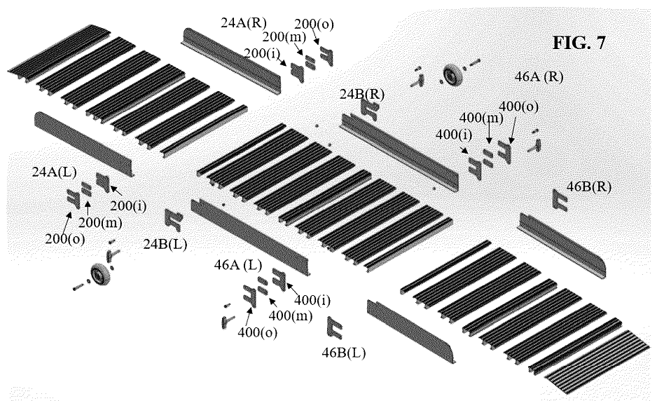

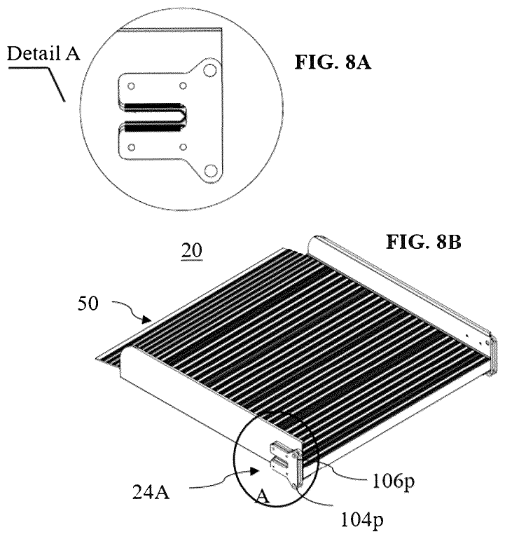

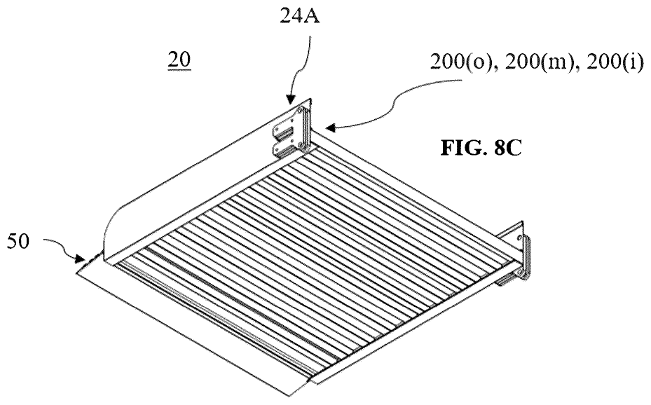

FIGS. 6A-6D illustrate the left-side configurations of the first and second hinge assemblies 24(L) and 46(L). The right-side assemblies 24(R) and 46(R) have a mirror image structure Turning now to FIG. 7, which is an exploded view of the ramp, the detailed configuration of each component of ramp 100 is illustrated. As previously discussed, the first hinge assembly 24 includes a first plate unit 24A, which is positioned on a side rail of the first ramp section 20 of the ramp. In certain embodiments, as shown in FIGS. 7, 8A, 8B, and 8C, the first plate unit 24A comprises an inner plate 200(i), a middle plate 200(m), and an outer plate 200(o), stacked together and aligned in a plane perpendicular to the axis of the rotation shaft 106.

The first hinge assembly 24 also includes second plate unit 24B, which is a single plate that, when connected to the first plate unit 24A, is aligned in the same plane as the middle plate 200(m). The second plate unit 24B features a hook-shaped top. In operation, the two rotation plates units of the hinge abut against one another in the closed position.

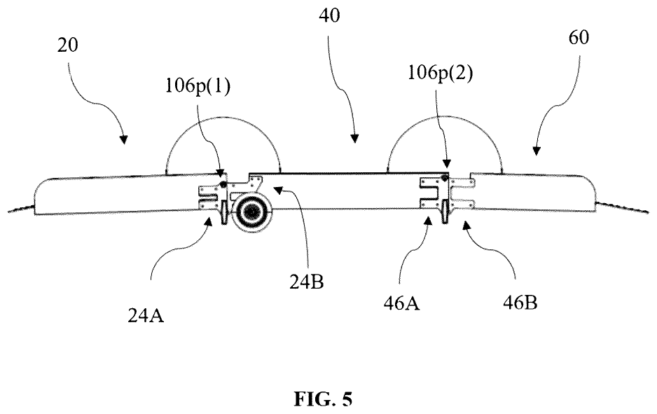

Referring back to FIG. 5, each plate in the first plate unit 24A and the second plate unit 24B includes the pivot hole 106p through which the rotation shaft 106 is inserted. As discussed, this shaft serves as a pivot axis to allow the ramp's first ramp section 20 to pivot relative to the ramp's second ramp section 40. When the ramp sections are fully open, locking pin 104 is inserted into the common holes to secure the ramp in its fully open configuration shown in FIG. 5.

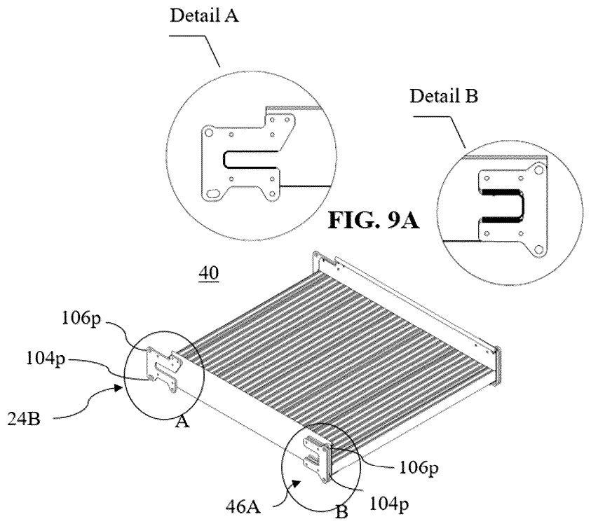

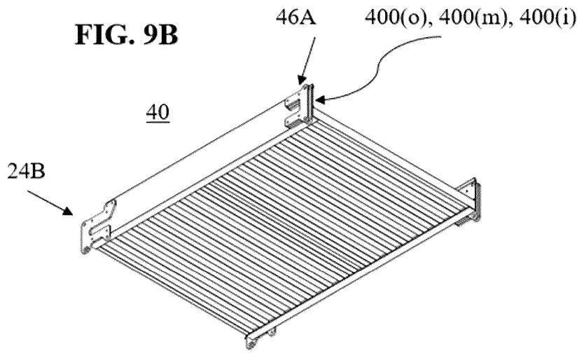

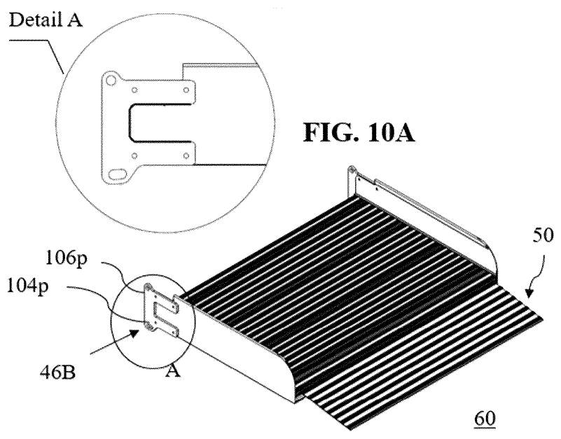

Referring to the various figures, including FIGS. 5, 7, 9A, 9B, and 10A, 10B, the second hinge assembly 46 has a slightly different structure than the first hinge assembly 24, but operates in the same matter. In particular, second hinge assembly 46 includes first plate unit 46A that is coupled to the side rail of the ramp's second ramp section 40 and the first plate unit consists of three stacked plates, inner plate 400(i), middle plate 400(m), and outer plate 400(o). s The second plate unit 46B of the second hinge assembly 46 is comprised of a single plate that is aligned in the same plane as the middle plate 400(m). And, like the first hinge assembly, the second hinge assembly includes both a pivot hole and a common hole through which a rotation shaft and a locking pin, respectively, extend.

In accordance with the present invention, and as particularly shown in FIG. 5, the pivot hole 106p(2) is coupled to the side rail of the second ramp section 40 at a position beneath the top edge of the side rail. Accordingly, when the ramp is in its closed position, such as shown in FIG. 1, the side rail of the ramp's third ramp section overlaps partially overlaps the side rail of the ramp's second/middle section. As will discussed further, the side rail of the ramp's third ramp section also overlaps the visible portion of side rail of the ramp's first ramp section. In such configuration, the fully folded ramp is extremely compact.

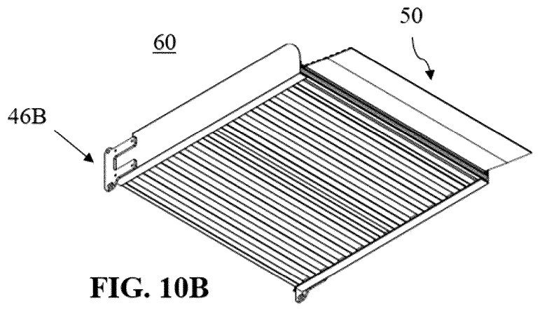

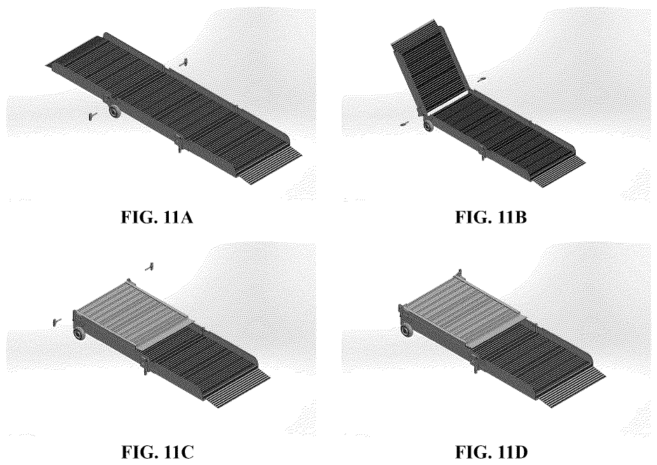

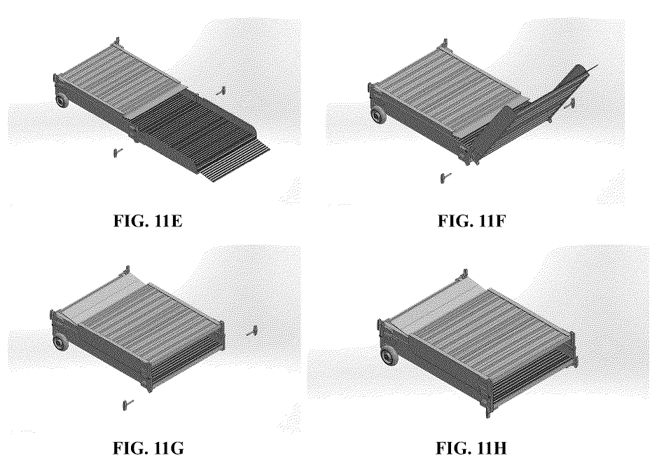

In accordance with the invention, and as shown in FIG. 5, the pivot hole 106p(1) of the first hinge assembly 24 is positioned in the overall structure at a location that is below the point at which the pivot hole 106p(2) of the second hinge assembly 46 is disposed. That is, the (first) pivot axis about which ramp sections 20 and 40 pivot and (second) pivot axis about which ramp sections 40 and 60 pivot are at different heights relative to the surfaces of the ramp apparatus. This is graphically shown in FIGS. 11A through 11H (further discussed below). Accordingly, when the ramp is in its fully closed position, as shown in FIG. 1, the ramp's three sections are disposed compactly immediately above one in parallel alignment. Moreover, when the ramp is in its fully open position, such as shown in FIG. 5, the ramp's three sections are aligned along a single plane to thus provide a level ramp.

To facilitate such parallel configuration of the ramp sections when the ramp is fully closed and alignment of the ramp sections in a single plane when the ramp is fully open, the size/height of the various components, including at least the ramp sections respective side rails, and the locations of the pivot points of the hinges must be determined to result in such alignments, but such determination given the teachings herein are well within the abilities of those of ordinary skill in the art.

Moreover, and in accordance with the present invention, the structures of the hinges in combination with the ramp sections attached thereto in the manner described result in a configuration of the side rails of the ramp's three ramp sections that result in an overlapping of the side rails, in a horizontal configuration, when the ramp is in its fully closed position, as will be described.

As best shown in FIG. 4B, which is a bottom view of the ramp in its fully open position, the structures of the hinges results in three ramp sections that are of different widths (i.e., distances between each ramp's left and right hinge). That is, and as shown, ramp section 20 (inclusive of its rails) has a smaller width than ramp section 40 (inclusive of its rails), which in turn has a smaller width than ramp section 60 (inclusive of its rails).

As discussed herein, each hinge has two plate units that have different structures and connection positions (also called coupling positions) (i.e., that couple to the side rail of a respective ramp section) that are in different planes (see FIG. 4B). As also shown in FIG. 4B, the two hinges coupled to the left side of middle ramp section 40 (i.e., the left side of the underside of ramp section 40 shown in FIG. 4B) are coupled to the ramp section 40 via the hinges' second plate unit 24B (e.g., see FIG. 6A) with the hinges' first plate unit 24A being coupled to the ramp section 20. As previously discussed, the first plate unit of each hinge is comprised of several plate components whereas the second plate unit is comprised of a single plate.

However, the two hinges that are coupled to the right side of middle ramp section 40 (FIG. 4B) are attached to the ramp section 40 via the hinges' first plate unit 46A (e.g., see FIG. 6B) with the hinges' second plate unit 46B being coupled to the ramp section 60.

When the ramp is in the process of being closed, ramp section 20 is first fully pivoted relative to ramp section 40, and given the different widths of the two ramp sections, the two side rails of ramp section 20 are disposed immediately within the boundaries of the two side rails of ramp section 40. This is partially shown at the left side of the illustration in FIG. 1 wherein one side of ramp section 20 (disposed at the bottom) is shown overlapping the side rail of middle ramp section 40 (disposed immediately above the lower ramp section at the left most portion of FIG. 1). When closed as shown in FIG. 1, ramp sections 20 and 40 are immediately adjacent to one another along their length and in disposed in parallel, overlapping alignment.

Thereafter, and referring to both FIGS. 1, 4A and 4B, ramp section 60 is pivoted relative to middle ramp section 40 until the two ramp sections are immediately adjacent one another and in parallel, overlapping alignment. Similar to the relation between the side rails of ramp sections 20 and 40, when fully closed, the two side rails of middle ramp section 40 are disposed immediately within the boundaries of the two side rails of ramp section 60. As shown in FIG. 1, in this fully closed position, ramp section 60 (i.e., the top-most section in FIG. 1) has its two side rails exterior to and covering the other two ramp sections (including their respective side rails).

### Positions and Movement/Ramp Transition

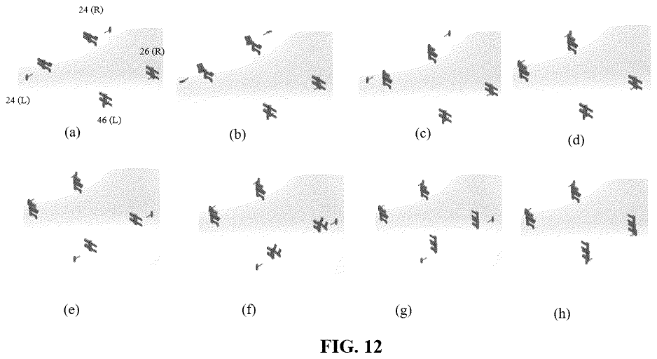

FIGS. 11A through 11H, shows the ramp of the invention it is various positional states when the ramp is transitioned from its fully open position to its fully folded position. FIG. 12 shows the respective positions/configuration of the hinge assemblies of the present invention when the ramp is in the states shown in FIGS. 11A through 11H.

In FIG. 11A, the ramp 100 is shown in its fully open position. To initiate folding, the locking pins are removed from the hinge assemblies, which allows the first and second ramp sections 20 and 40 to rotate relative to one another. FIG. 11B shows the first ramp section 20 partially pivoted. A user or other person then pivots the first ramp section until it is fully on top of and resting on the second/center ramp section 40, as shown in FIG. 11C. The locking pins then may be inserted back into the common hole for storage, i.e., to prevent the locking pins from getting lost, as shown in FIG. 11D.

The other set of locking pins are removed, as shown in FIG. 11E, to allow the second and third ramp sections 40 and 60 to be rotatable relative to one another. With the locking pins removed, the third ramp section 60 is rotated, as shown in FIG. 11F, and continues to rotate until it is resting on top of the first ramp section 20, as FIG. 11G. The second set of locking pins then may reinserted into the common holes for storage, as shown in FIG. 11H.

### Hinge Assembly Structure/Features

As described, the hinge assemblies employ a novel structure that includes stacked hinge plates (see, FIGS. 6A-6D) to provide sufficient strength to accommodate relatively long ramps, such as a ramp that is 10 feet long, in which such long ramp is divided into three sections as described herein. An exemplary ramp employing the present invention is 120 inches long (10 feet long) and 30-32 inches wide, with a width of 30 inches to ensure it can be used effectively at a doorway, making it suitable to be used for wheelchairs with an occupant and other needs that are common within the ramp industry. Other exemplary ramp sizes of ramps of the invention include 8 feet long and 12 feet long. Other lengths and widths may be employed as would be appreciated by those of ordinary skill in the art.

The novel hinge assemblies as described herein utilizes stacked hinge plates that distributes the loads across the plates and puts the locking pin, which may be a clevis pin or other suitable pin, in a double shear condition hence greatly increasing the strength of the hinge assembly, as compared to hinges that are commonly used within ramps. To improve durability and performance, a pivot bushing may be incorporated into the locking pin to facilitate a smoother operation and reduce wear. The pivot bushing can be securely integrated into the hinge plates through various methods, such as press fitting, welding, bolting, or other fastening techniques. Any method that ensures the pivot bushing remains firmly in place, properly aligned with the locking pin, and capable of delivering smooth operation, minimizing wear, and evenly distributing stress across the hinge assembly is suitable. The stacked hinge plate structure in combination with the siderail structure as described herein further allows the ramp sections to fold and overlap each other when closed, thus providing the compacts as illustrated herein.

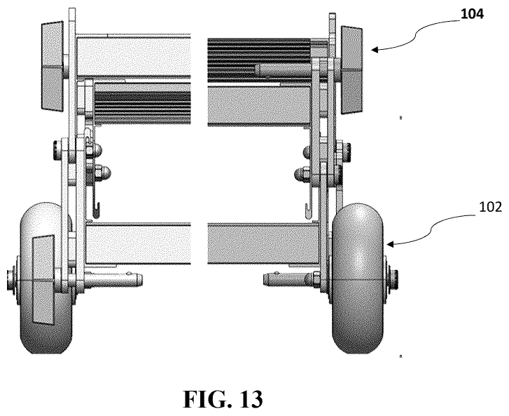

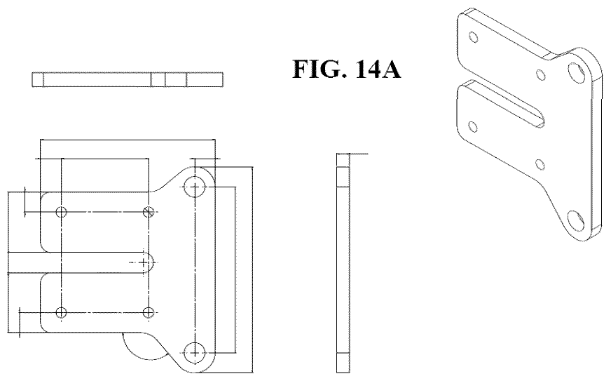

FIG. 13 shows the ramp (with some portions removed for visibility) in the fully closed position. In such position, the three ramp sections are in close proximity, resting on top of one another, in parallel fashion. The locking pins are shown inserted within the common holes of each of the hinge assemblies, showing the double shear condition. That is, each locking pin extends through and distribute the load amongst multiple plates of the hinge assemblies, thus providing additional strength.

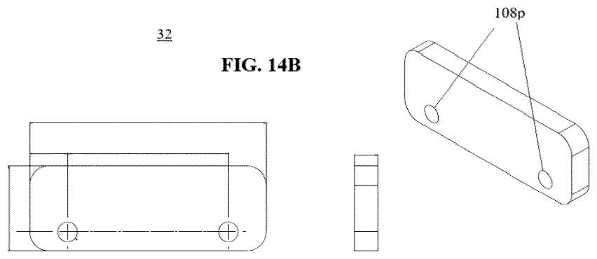

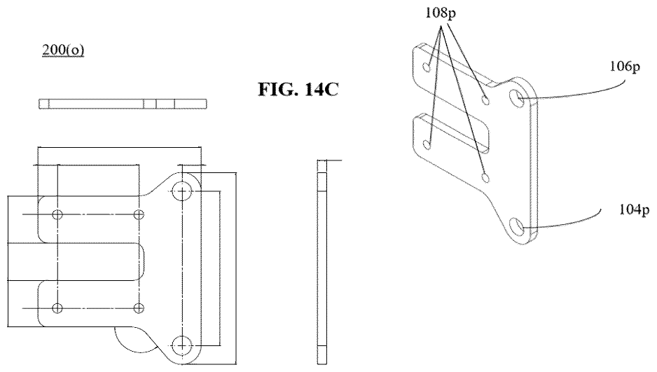

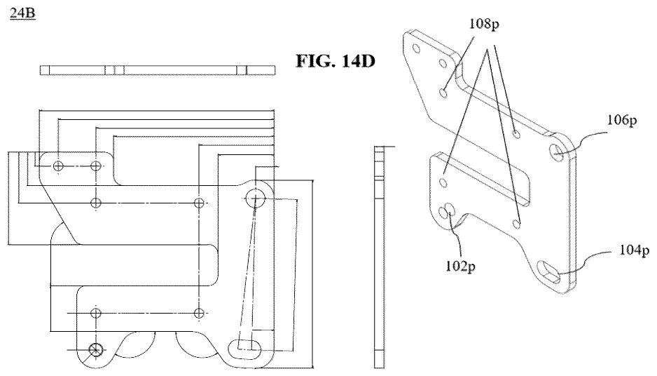

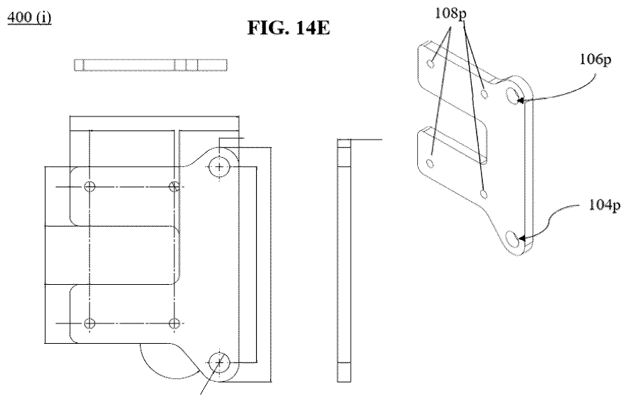

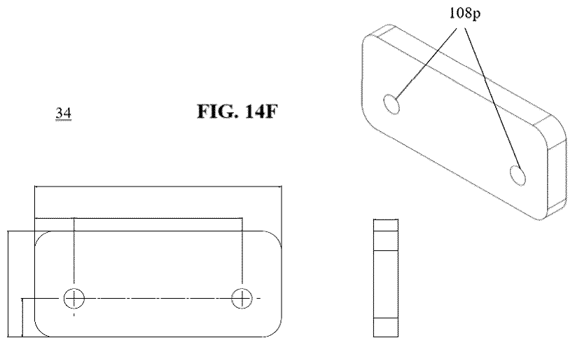

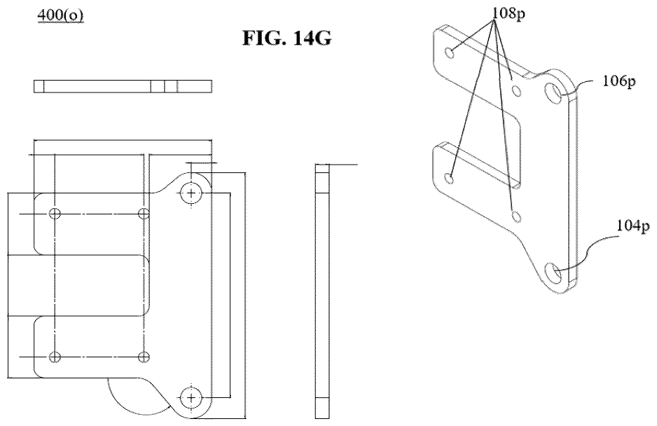

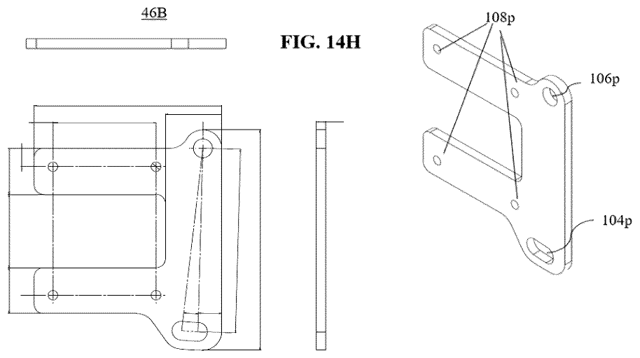

FIGS. 14A through 14H illustrate an exemplary embodiment of the hinge assembly structures of the present invention, including the structures of the individual plates of those hinge assemblies. FIGS. 14D and 14H shows an alternative embodiment in which common hole 104p of each of the hinge assemblies is elongated to allow for the insertion of the locking pins into the common holes without the need for all the common holes (i.e., including the common holes of the second plate units of each hinge assembly) to be perfectly in alignment. That is, the elongated shape of the locking holes in the plate units shown in FIGS. 14D and 14H allow for slight alignment variances that may naturally occur in a fully open ramp, thus allowing for easier insertion of the locking pins after the ramp is fully opened and deployed. The elongated holes further allow the hinge to absorb additional stress and also prevents or at least minimizes misalignment under load, thereby resulting in a more stable locking mechanism.

As illustrated, the ramp of the invention employs multiple ramp sections and a set of locking pins to lock the deployed ramp in its fully open position, all without the need for special tools. The locking pins may include appropriately sized handles for ease of use. The locking pins may differ than that show. For each, the locking pins may include a pull ring or other structure known in the art.

### Side Rails

As is appreciated, side rails in a ramp serve as guides and enhance safety by reducing the likelihood that a wheelchair, cart or other device, including a person, from falling off the ramp during use. The present invention, however, utilizes the side rails in combination with the hinge assemblies that are coupled thereto to provide a ramp assembly structure that provides the various features and benefits as discussed herein, including, in particular, the beneficial feature of being extremely compact when the ramp is fully closed.

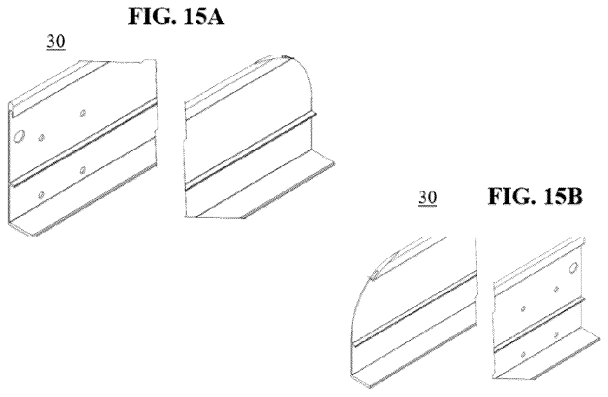

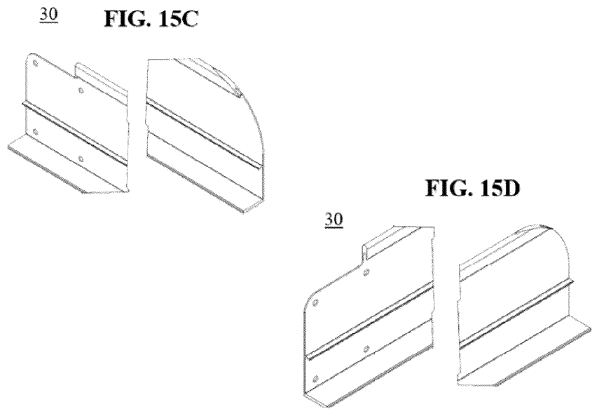

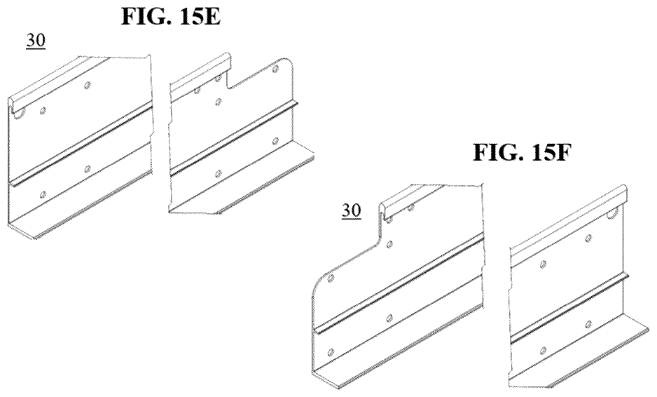

Portions of exemplary side rails that may be utilized in accordance with the invention are illustrated in FIGS. 15A-15F. The openings with the side rails shown are for connection to the hinge assemblies of the present invention. The hinge assemblies may be fixed to the side rails in any suitable known in the art, such as via bolts, screws, welding, etc.

### Handle and Wheels for Transportation of the Ramp

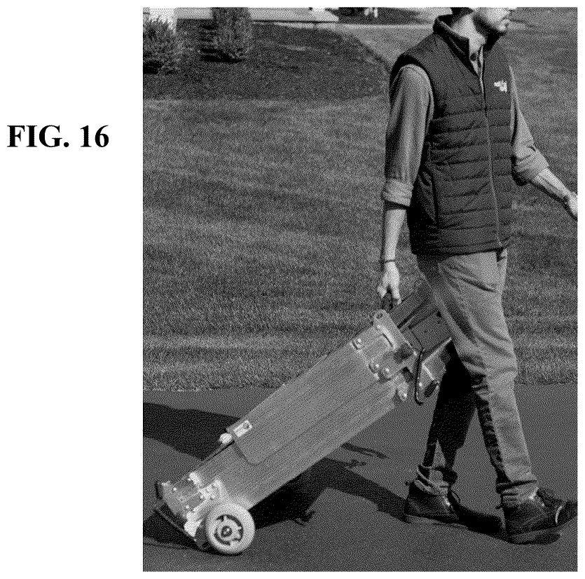

Various figures show the ramp of the invention with wheels, including FIGS. 1 and 13. FIGS. 3A and 7 show the hinge assemblies that include wheel shafts 102s for inclusion and supporting of appropriately sized wheels within the ramp assembly. FIG. 16 shows a person transporting the ramp with the wheels rolling along the ground, for ease of movement of the ramp from one location to another. The ramp also may include a handle as shown in FIG. 16. For further comfort by a user during transport of the ramp of the present invention.

However, in certain embodiments, the ramp assembly of the invention need not include wheels and/or a handle.

### Other Features

The top surface of the three sections of the ramp incorporates a combination of features that ensure both functionality and safety during operation. These features of the top surface of the ramp include, but are not limited to:

Double Pocket Plank Profile: The top surface of the ramp is configured with a double pocket plank profile, which enhances load distribution and structural integrity. This profile helps to evenly distribute the weight across the surface, ensuring stability even under heavy loads. The pockets also provide additional space for reinforcement materials, enhancing the ramp's strength without adding extra weight.

OSHA 1.5-inch Hook End Cap: To comply with safety standards, the ramp features an OSHA-compliant 1.5-inch hook end cap at both ends, preventing accidents by creating a secure stop for the ramp, ensuring proper alignment with the ground or other surfaces. The hook end cap also serves as a secure attachment point, making the ramp safer for use in a variety of environments.

Varied Plank Sizes: Moreover, as shown in FIG. 7, the ramp features planks of varying sizes to accommodate different structural and functional requirements. Specifically, the ramp incorporates double pocket plank profiles in sizes such as 3 inches and 6 inches, which are strategically positioned between each pair of hook end caps. This variation in plank size allows for a more flexible and adaptable surface size of each section, ensuring that the ramp can be tailored to meet specific load distribution needs or space constraints. The 3-inch and 6-inch planks work together to enhance the overall stability of the ramp, ensuring that each section is securely connected, with minimal gaps between the ramp's surfaces.

These combined features make the ramp of the present invention durable, user-friendly, and safe, offering high levels of stability, ease of use, and adaptability for a wide range of applications.

Having described the invention in detail, the following is a partial list of the benefits of the foldable ramp of the present invention.
(1) Foldable Design for Space Efficiency. The inventive ramp is configured to fold into a compact size, making it easy to transport and store. The three sections of the ramp stack parallel to each other when folded, optimizing space usage. The folding configuration allows the ramp to be stored in a compact form, minimizing storage space. This feature ensures the ramp remains accessible and easy to store when not in use.
(2) Modular Configuration for Flexibility: In certain embodiments, the ramp can be disassembled into individual sections, allowing for separate storage or transport. In such embodiments, each of the rotation shafts is removable for disconnection of the ramp sections from one another. According, in such embodiments, each ramp section can be separately stored thus allowing for the use of relatively small storage spaces if necessary or desirable. Furthermore, in such embodiments, a ramp section can be replaced if necessary or desired. A replacement ramp section may have a length different from the original ramp section if desired in order to provide an overall ramp length that is different than the original ramp length.
(3) Smooth Folding and Unfolding Mechanism: Hinge assemblies enable relatively easy and smooth folding and unfolding of the ramp sections. Such ease of folding allows for quick setup and storage.
(4) Locking Mechanism for Secure Operation: Locking pins secure the ramp sections in place during use, preventing unintended movement and enhancing safety. The locking mechanism ensures that the ramp stays stable under load.
(5) Ease of Transportation and Portability: The ramp's lightweight, foldable, and modular configuration, and the use of the wheel and the handle, makes it easy to carry and transport, enhancing convenience for users.
(6) Adaptability for Various Applications: The ramp is configured for aligned surfaces, making it suitable for use in homes, vehicles, and public spaces. With elongated holes, in certain embodiments, within the hinge plates enables smoother locking pin engagement and prevents misalignment under load across various surfaces for safe and effective operation. Transition plates at the ends of the ramp sections create smoother transitions between surfaces to improve safety.
(7) Maximized Structural Integrity: The configuration of the hinge plates ensures proper alignment of the ramp sections, enhancing overall stability during use. This feature also reduces stress concentrations, improving the ramp's durability.

It is appreciated that while the present invention has been described with reference to specific structural features as shown in the figures and/or discussed in this detailed description, various changes may be made without departing from the spirit and scope of the invention.

For example, the hinge assemblies are optimized for a three-section ramp, the ramp is not restricted to three sections. The invention may be embodied within a two-section ramp. As another example, the present invention in certain embodiments may employ four sections, or more. Moreover, the lengths and widths of each of the ramp sections may vary and be different than that discussed herein, as would be appreciated by those of ordinary skill in the art. Such flexibility accordingly results in the inventive ramp's customization for diverse applications.

As another example, the structure, including the shape, of the individual plates of the hinge assemblies is not constrained to the specific geometries shown in the figures. The plates and the hinge assemblies overall may be modified in shape, size, and other characteristics as would be appreciated by those of ordinary skill in the art. Furthermore, the hinge assemblies may be made of a different number of constituent components than that described herein.

Other variations may be made as would be appreciated to those of ordinary skill in the art. Therefore, it is to be understood that other expedients/variations/embodiments may be employed but that stay within the meaning, scope and spirit of the invention.

Having described the present invention including the various features and variations thereof, it is intended that the appended claims be interpreted as including the embodiments described herein, the alternatives mentioned above, and all equivalents thereto.

What is claimed is:

1. A foldable ramp assembly, comprising:
first, second and third ramp sections, each of the first, second and third ramp sections having a respective top surface;
a pair of first hinge assemblies coupled to the first and second ramp sections and enabling about a first axis rotatable movement of the first and second ramp sections relative to one another;
a pair of second hinge assemblies coupled to the second and third ramp sections and enabling about a second axis rotatable movement of the second and third ramp sections relative to one another;
the first and second hinge assemblies configured to allow the first, second, and third ramp sections to be configured in a fully open position in which the top surfaces of the first, second, and third ramp sections are adjacent to one another and disposed substantially along a single plane to provide a continuous elongated surface;
the first and second hinge assemblies configured to allow the first, second, and third ramp sections to be configured in a fully closed position in which the top surfaces of the first, second, and third ramp sections are disposed along separate planes that are substantially parallel to one another.

2. The foldable ramp assembly of claim 1, wherein the first and second hinge assemblies are configured, when the foldable ramp assembly is in the fully open position, to enable rotation of the first and third ramp sections relative to the second ramp section in directions opposite to one another.

3. The foldable ramp assembly of claim 1, wherein, when the foldable ramp assembly is in the fully closed position, the first and third ramp sections are disposed on the same side of the second ramp section.

4. The foldable ramp assembly of claim 1, wherein each of the first, second and third ramp sections has a respective pair of side rails, each of the side rails extending upward from opposing edges of the respective ramp section's top surface.

5. The foldable ramp assembly of claim 4, wherein:
each of the first hinge assemblies is coupled to respective rails of the first and second ramp sections to define a first pivot axis about which the first and second ramp sections rotate relative to one another;
each of the second hinge assemblies is coupled to respective rails of the second and third ramp sections to define a second pivot axis about which the second and third ramp sections rotate relative to one another;
wherein the first pivot axis and second pivot axis are disposed at different heights relative to the top surfaces of the first, second and third ramp sections when in the fully open position.

6. The foldable ramp assembly of claim 5, wherein the first ramp section has a width smaller than a width of the second ramp section, and the width of the second ramp section is smaller than a width of the third ramp section so that the respective rails of each side of the first, second, and third ramp sections are disposed adjacent to one another when the first, second, and third ramp sections are in the fully closed position.

7. The foldable ramp assembly of claim 1, wherein each of the first hinge assemblies and the second hinge assemblies comprises:
first and second plate units rotatably coupled to one another;
the first plate unit comprising an outer plate, an inner plate, and a middle plate disposed between the outer and inner plates, the middle plate configured to provide a space between the outer and inner plates, and
the second plate unit configured as a single plate, and configured to be rotatable relative to the first plate unit so that a portion of the second plate unit is disposed in the space between the outer and inner plates of the first plate unit when the first, second, and third ramp sections are in the fully closed position.

8. The foldable ramp assembly of claim 7, wherein:
the inner plate of the first plate unit of each of the first hinge assemblies is coupled to opposing sides of the first ramp section;
the second plate of each of the first hinge assemblies is coupled to opposing sides of the second ramp section,
wherein positions at which each inner plate is coupled to the first ramp section is disposed along a different respective plane than a corresponding respective plane at which each second plate is coupled to the second ramp section.

9. The foldable ramp assembly of claim 8, wherein:
the inner plate of the first plate unit of each of the second hinge assemblies is coupled to opposing sides of the second ramp section;
the second plate of each of the second hinge assemblies is coupled to opposing sides of the third ramp section,
wherein positions at which the inner plate of the first plate unit of each of the second hinge assemblies is coupled to the second ramp section is disposed along a different respective plane than a corresponding respective plane at which each second plate of each of the second hinge assemblies is coupled to the third ramp section.

10. The foldable ramp assembly of claim 7, wherein each of the first and second plate units of each of the first and second hinge assemblies has a respective common hole, the common holes of the first and second plate units of each respective hinge assembly being positionally aligned when in the fully open position and adapted to receive a respective locking pin in the fully open position to prevent rotational movement of the respective hinge assembly.

11. The foldable ramp assembly of claim 10, wherein the common hole of the second plate unit of each of the first and second hinge assemblies is elongated so that respective first and second plate units of each of the first and second hinge assemblies are able to receive the respective locking pin when there is an alignment variance between the common holes of the first and second plate units of each respective hinge assembly.

12. The foldable ramp assembly of claim 1, wherein each of the first hinge assemblies includes a wheel adapted to allow the foldable ramp assembly to be moved via rolling over the wheels when the first, second and third ramp sections are in the fully closed position.

13. The foldable ramp assembly of claim 1, wherein each of the first hinge assemblies and second hinge assemblies comprises first and second plate units rotatably detachably coupled to one another so that each of the first, second, and third ramp sections are fully disconnectable from one another via detaching each of the first and second plates.

14. The foldable ramp assembly of claim 1, further comprising a transition plate, rotatably connected to the first ramp section and/or the third ramp section, wherein the transition plate is configured to rotate relative to the surface of the corresponding ramp section, with a limited rotational range.

15. The foldable ramp assembly of claim 14, wherein
the transition plate comprises a rounded or near-rounded edge dimensioned to fit and rotate within and a “C”-shaped channel formed on the corresponding ramp section.
